(19) United States
(12) Patent Application Publication
(10) Pub. No.: US 2006/0048157 A1
(43) Pub. Date: Mar. 2, 2006

(54) Dynamic grid job distribution from any resource within a grid environment

(75) Inventors: Christopher J. Dawson, Arlington, VA (US); Craig W. Fellenstein, Brookfield, CT (US); Rick A. Hamilton II, Charlottesville, VA (US); Joshy Joseph, Poughkeepsie, NY (US)

Correspondence Address: Amy J. Pattillo, P.O. Box 161327, Austin, TX, 78716-1327, US

(73) Assignee: International Business Machines Corporation, Armonk, NY (US)

(21) Appl. No.: 10/850,554

(22) Filed: May 18, 2004

(51) Int. Cl. G06F 9/46

(52) U.S. Cl. 718/104

(57) ABSTRACT

A method, system, and program for dynamic grid job distribution from any resource within a grid environment. Multiple resources enabled to handle grid jobs are connected via at least one network within a grid environment. Each of the multiple resources is enabled to distribute an availability and ability to handle grid jobs within the grid environment. Each of the multiple resources is also enabled to access the availability and ability to handle grid jobs of all of the other resources within the grid environment. The distribution of and access to current information may be organized as a hierarchical resource directory system or as a peer-to-peer resource distribution system. Further, resources within the grid environment are also enabled to receive a grid job and a job object, as a receiving resource. The job object received at a receiving resource describes at least one requirement for the grid job submitted to the receiving resource. The receiving resource determines the most suitable resource to handle the job from among the grid resources, wherein the ability to handle grid jobs by the most suitable resource meets the at least one requirement for the grid job and the most suitable resource indicates an availability to receive the grid job. The receiving resource then controls submission of the job to the most suitable resource for handling the job.

### BACKGROUND OF THE INVENTION

1. Technical Field

The present invention relates in general to improved performance and efficiency in grid environments and in particular to a method for dynamic job distribution within a grid environment. Still more particularly, the present invention relates to dynamic job routing from any resource within a grid environment independent of centralized, dedicated job schedulers, such that bottlenecks within the grid environment are reduced.

2. Description of the Related Art

Ever since the first connection was made between two computer systems, new ways of transferring data, resources, and other information between two computer systems via a connection continue to develop. In typical network architectures, when two computer systems are exchanging data via a connection, one of the computer systems is considered a client sending requests and the other is considered a server processing the requests and returning results. In an effort to increase the speed at which requests are handled, server systems continue to expand in size and speed. Further, in an effort to handle peak periods when multiple requests are arriving every second, server systems are often joined together as a group and requests are distributed among the grouped servers. Multiple methods of grouping servers have developed such as clustering, multi-system shared data (sysplex) environments, and enterprise systems. With a cluster of servers, one server is typically designated to manage distribution of incoming requests and outgoing responses. The other servers typically operate in parallel to handle the distributed requests from clients. Thus, one of multiple servers in a cluster may service a client request without the client detecting that a cluster of servers is processing the request.

Typically, servers or groups of servers operate on a particular network platform, such as Unix or some variation of Unix, and provide a hosting environment for running applications. Each network platform may provide functions ranging from database integration, clustering services, and security to workload management and problem determination. Each network platform typically offers different implementations, semantic behaviors, and application programming interfaces (APIs).

Merely grouping servers together to expand processing power, however, is a limited method of improving efficiency of response times in a network. Thus, increasingly, within a company network, rather than just grouping servers, servers and groups of server systems are organized as distributed resources. There is an increased effort to collaborate, share data, share cycles, and improve other modes of interaction among servers within a company network and outside the company network. Further, there is an increased effort to outsource nonessential elements from one company network to that of a service provider network. Moreover, there is a movement to coordinate resource sharing between resources that are not subject to the same management system, but still address issues of security, policy, payment, and membership. For example, resources on an individual's desktop are not typically subject to the same management system as resources of a company server cluster. Even different administrative groups within a company network may implement distinct management systems.

The problems with decentralizing the resources available from servers and other computing systems operating on different network platforms, located in different regions, with different security protocols and each controlled by a different management system, has led to the development of Grid technologies using open standards for operating a grid environment. Grid environments support the sharing and coordinated use of diverse resources in dynamic, distributed, virtual organizations. A virtual organization is created within a grid environment when a selection of resources, from geographically distributed systems operated by different organizations with differing policies and management systems, is organized to handle a job request.

An important attribute of a grid environment, that distinguishes a grid environment from merely that of another network management system, is the quality of service maintained across multiple diverse sets of resources. A grid environment does more than just provide resources; a grid environment provides resources with a particular level of service including response time, throughput, availability, security, and the co- allocation of multiple resource types to meet complex user demands.

To provide quality of service for grid jobs, a centralized job scheduler is typically relied on to route jobs to the available resources within the Grid environment that will meet the level of service required. The typical role of a centralized job scheduler is first tracking the availability of resources within the Grid infrastructure. Then, the centralized job scheduler uses this information to determine which resource is the most suitable for execution of a particular job. Multiple, heterogeneous client systems typically rely on the centralized job scheduler to receive job requests and distribute those job requests to the most suitable resource available after the job request is submitted.

Using a centralized job scheduler or multiple centralized schedulers, however, in a grid environment, constrains the performance of the grid. In particular, the centralized job scheduler represents a bottleneck through which all jobs must be sent. If the centralized job scheduler is overloaded, the performance of the entire grid environment is degraded. Further, with the potentially geographically dispersed nature of grid resources, receiving updates at the centralized job scheduler about the availability of resources around the globe is time consuming, further degrading the performance of the grid environment.

In view of the foregoing, it would be advantageous to provide a method, system, and program for scheduling and distributing jobs within a grid environment without the need for centralized job schedulers. In particular, it would be advantageous to provide a method, system, and program for each resource to manage the distribution of job requests to the most suitable resource available within a grid environment after the job request. Further, it would be advantageous to provide a method, system, and program for organizing grid resources so that each resource distributes information about its availability and ability is enabled to efficiently access information about the availability and ability of any other resources within the grid environment.

### SUMMARY OF THE INVENTION

In view of the foregoing, the method, system, and program provide improved performance in grid environments and in particular provide improved performance through dynamic job distribution within a grid environment. Still more particularly, the present invention provides a method, system, and program for dynamic job distribution from any resource within a grid environment independent of centralized, dedicated job schedulers, such that bottlenecks within the grid environment are reduced. Furthermore, in the present invention, each resource distributes information about the availability of that resource in a manner such that all other resources are enabled to efficiently access the information.

According to one embodiment, multiple resources are connected within a grid environment, wherein each of the resources is enabled to handle grid jobs through the provision of grid services. Each of the multiple resources is enabled to distribute an availability and ability to handle grid jobs within the grid environment. Each of the multiple resources is also enabled to access the availability and ability to handle grid jobs of all of the other resources within the grid environment. The distribution of and access to current information may be organized as a hierarchical resource directory system or as a peer-to-peer resource distribution system.

Each resource is also enabled to receive a grid job and a job object. The job object received at a receiving resource describes the requirements for the grid job submitted to the receiving resource. Requirements may include security requirements, type of resource, and policy requirements. The receiving resource determines the most suitable resource to handle the job from among the grid resources, wherein the ability to handle grid jobs by the most suitable resource meets the requirements for the grid job and the most suitable resource indicates an availability to receive the grid job. The receiving resource then controls submission of the job to the most suitable resource for handling the job.

In a hierarchical resource directory system, a local resource directory receives the availability and ability to handle jobs from each of a selection of local resources, including the receiving resource. The receiving resource, or any other resources from the selection of local resources, requests a list of selection of local resources with availability and ability description. If the most suitable resource is not described in the list of the selection of local resources, then the receiving resource requests the address of a parent resource directory from the local resource directory. The receiving resource then connects to the parent resource directory and requests the list of a second selection of resources from which the parent resource directory receives availability and ability updates. The receiving resource continues to access resource directories within the hierarchy of resource directories and requests lists of resource availability and ability from each, until the most suitable resource is located or the job object times out after a particular number of directory accesses.

In a peer-to-peer resource distribution system, each resource distributes a node description message to a selection of local resources and a parent resource. The node description message specifies each resource's availability and ability to handle grid jobs. Each resource receiving the node description message distributes the node description message to other selections of local resources and other parent resources. Each resource receiving a node description message also stores the node description message. Then, the receiving resource compares the job object with the stored node description messages. If the most suitable resource is not determined from the stored node description messages, then the receiving resource sends the job object to the parent resource. The parent resource then determines whether the most suitable resource is available from the resources sending node description messages to the parent resource. If the most suitable resource is not determined from the parent resource stored node description messages, then the parent resource distributes the job object to its parent resource. The job object continues to pass from parent resource to parent resource until the most suitable resource is located or the job object times out after a particular number of passes.

In either the hierarchical resource directory system or the peer-to-peer resource distribution system, resources are preferably arranged according to geographical location. First, the local set of resources searched for the most suitable resource are within a local geographic proximity. Then, as the searching for the most suitable resource moves from one directory to another or one parent resource to another, the resources are geographically farther from the receiving resource.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system which may be implemented in a grid environment and in which the present invention may be implemented;

FIG. 2 depicts a block diagram of one embodiment of a client system interfacing with the general types of components within a grid environment;

FIG. 3 depicts a block diagram of one example of an architecture that may be implemented in a grid environment;

FIG. 4 depicts an illustrative representation of one embodiment of the logical infrastructure of a grid environment in which the present invention may be implemented

FIG. 5 depicts a block diagram of a job object for a job submitted within a grid environment in accordance with the method, system, and program of the present invention

FIG. 6 depicts a block diagram of a grid manager for each resource in accordance with the method, system, and program of the present invention;

FIG. 7 depicts a block diagram of a grid manager for each resource in accordance with the method, system, and program of the present invention;

FIG. 8 depicts a block diagram of a resource group database used in a peer-to-peer resource distribution system in accordance with the method, system, and program of the present invention;

FIG. 9 depicts a block diagram of a logical representation of a peer-to-peer resource distribution system in accordance with the method, system, and program of the present invention;

FIG. 10 depicts a block diagram of a resource directory in a hierarchical resource directory system in accordance with the method, system, and program of the present invention;

FIG. 11 depicts an illustrative representation of a hierarchical resource directory in accordance with the method, system, and program of the present invention;

FIG. 12 depicts a high level logic flowchart of a process and program for controlling a grid job submission from a client system in accordance with the method, system, and program of the present invention; and

FIGS. 13a-13c depict a high level logic flowchart of a process and program for controlling the distribution of a new job object from any resource within the grid environment in accordance with the method, system, and program of the present invention.

### DETAILED DESCRIPTION OF THE PREFERRED EMBODIMENT

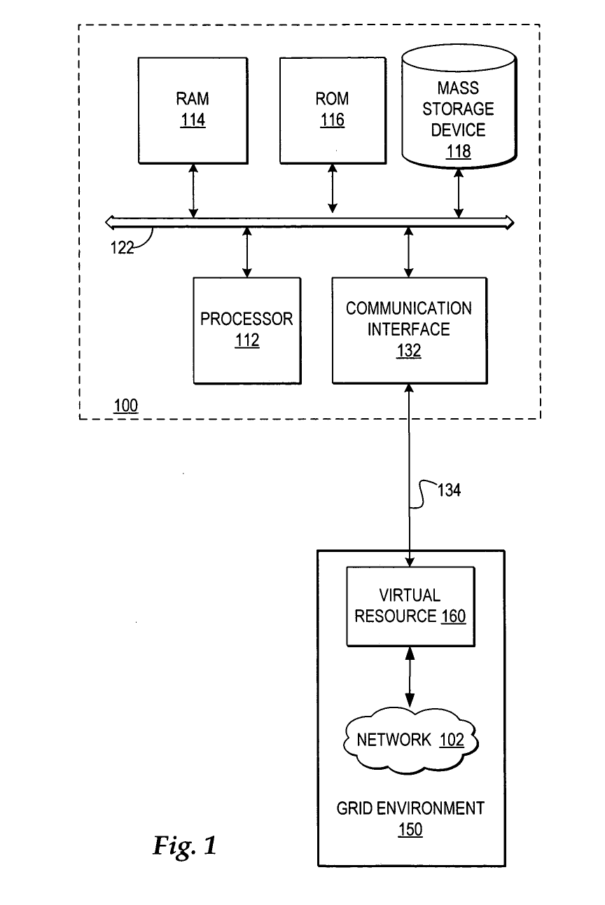

Referring now to the drawings and in particular to FIG. 1, there is depicted one embodiment of a computer system which may be implemented in a grid environment and in which the present invention may be implemented. As will be further described, the grid environment includes multiple computer systems managed to provide resources. Additionally, as will be further described, the present invention may be executed in a variety of computer systems, including a variety of computing systems, mobile systems, and electronic devices operating under a number of different operating systems managed within a grid environment.

In one embodiment, computer system 100 includes a bus 122 or other device for communicating information within computer system 100, and at least one processing device such as processor 112, coupled to bus 122 for processing information. Bus 122 preferably includes low-latency and higher latency paths that are connected by bridges and adapters and controlled within computer system 100 by multiple bus controllers. When implemented as a server system, computer system 100 typically includes multiple processors designed to improve network servicing power.

Processor 112 may be a general-purpose processor such as IBM's PowerPC™ processor that, during normal operation, processes data under the control of operating system and application software accessible from a dynamic storage device such as random access memory (RAM) 114 and a static storage device such as Read Only Memory (ROM) 116. The operating system may provide a graphical user interface (GUI) to the user. In a preferred embodiment, application software contains machine executable instructions that when executed on processor 112 carry out the operations depicted in the flowcharts of FIGS. 11, 12, 13a-13c, and other operations described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but will be understood to also be provided by an external device. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, the present invention may be downloaded as a computer program product, wherein the program instructions may be transferred from a remote virtual resource, such as a virtual resource 160, to requesting computer system 100 by way of data signals embodied in a carrier wave or other propagation medium via a network link 134 (e.g. a modem or network connection) to a communications interface 132 coupled to bus 122. Virtual resource 160 may include a virtual representation of the resources accessible from a single system or systems, wherein multiple systems may each be considered discrete sets of resources operating on independent platforms, but coordinated as a virtual resource by a grid manager. Communications interface 132 provides a two-way data communications coupling to network link 134 that may be connected, for example, to a local area network (LAN), wide area network (WAN), or an Internet Service Provider (ISP) that provide access to network 102. In particular, network link 134 may provide wired and/or wireless network communications to one or more networks, such as network 102, through which use of virtual resources, such as virtual resource 160, is accessible. According to an advantage of the present invention, the grid management services within grid environment 150 are distributed across the multiple resources, such as the multiple physical resources within virtual resource 160, so that there is not a need for a centralized job scheduler within grid environment 150.

As one example, network 102 may refer to the worldwide collection of networks and gateways that use protocols, such as Transmission Control Protocol (TCP) and Internet Protocol (IP), to communicate with one another. Network 102 uses electrical, electromagnetic, or optical signals that carry digital data streams. The signals through the various networks and the signals on network link 134 and through communication interface 132, which carry the digital data to and from computer system 100, are exemplary forms of carrier waves transporting the information. It will be understood that alternate types of networks, combinations of networks, and infrastructures of networks may be implemented.

When implemented as a server system, computer system 100 typically includes multiple communication interfaces accessible via multiple peripheral component interconnect (PCI) bus bridges connected to an input/output controller. In this manner, computer system 100 allows connections to multiple network computers.

Additionally, although not depicted, multiple peripheral components and internal/external devices may be added to computer system 100, connected to multiple controllers, adapters, and expansion slots coupled to one of the multiple levels of bus 122. For example, a display device, audio device, keyboard, or cursor control device may be added as a peripheral component.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

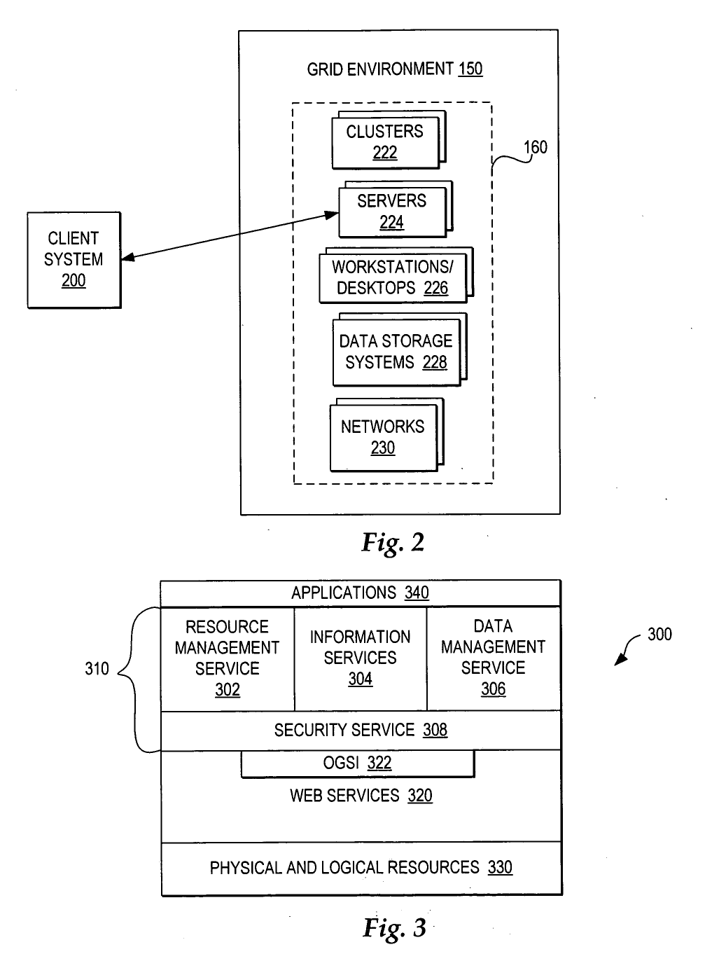

With reference now to FIG. 2, a block diagram illustrates one embodiment of a client system interfacing with the general types of components within a grid environment. In the present example, a grid environment 150 enables a client system 200 to interface with at least one grid resource within virtual resource 160. Physically, examples of grid resources within virtual resource 160 include, but are not limited to, server clusters 222, servers 224, workstations and desktops 226, data storage systems 228, and networks 230. Each of these physical resources may further be described as multiple types of discrete logical resources including, but not limited to, application resources, cpu processing resources, memory resources, and storage resources.

For purposes of illustration, the network locations and types of networks connecting the components within grid environment 150 are not depicted. It will be understood, however, that the components within grid environment 150 may reside atop a network infrastructure architecture that may be implemented with multiple types of networks overlapping one another. Network infrastructure may range from multiple large enterprise systems to a peer-to-peer system to a single computer system. Further, it will be understood that the components within grid environment 150 are merely representations of the types of components within a grid environment. A grid environment may simply be encompassed in a single computer system or may encompass multiple enterprises of systems.

The central goal of a grid environment, such as grid environment 150 is organization and delivery of resources from multiple discrete systems viewed as virtual resource 160 by client system 200. Client system 200, server clusters 222, servers 224, workstations and desktops 226, data storage systems 228, and networks 230 may be heterogeneous and regionally distributed with independent management systems, but enabled to exchange information, resources, and services through a grid infrastructure. Further, server clusters 222, servers 224, workstations and desktops 226, data storage systems 228, and networks 230 may be geographically distributed across countries and continents or locally accessible to one another.

According to an advantage of the present invention, grid environment 150 meets the central goal of organization and delivery of resources from multiple discrete systems through dynamic job routing from any resource within grid environment 150, rather than through a centralized job scheduler. In particular, rather than centralizing the job scheduling function, each resource distributes an availability and ability update in a manner such that all other resources within the grid environment are enabled to efficiently access availability and ability updates. Through the distribution of availability and ability updates, each resource is linked with all other resources and is enabled to efficiently locate and route jobs to the most suitable available resource within grid environment 150. Thus, when client system 200 submits jobs to one of the resources within virtual resource 160, that resource will manage the distribution of the job to the most suitable available resource within grid environment 150. In the example, client system 200 interfaces with one of servers 224 for submitting job requests, however, it will be understood that client system 200 may interface with other resources and that client system 200 may interface with multiple resources.

It is important to note that client system 200 may represent any computing system sending requests to one of the resources of grid environment 150. While the systems within virtual resource 160 are depicted in parallel, in reality, the systems may be part of a hierarchy of systems where some systems within virtual resource 160 may be local to client system 200, while other systems require access to external networks. Additionally, it is important to note, that systems depicted within virtual resources 160 may be physically encompassed within client system 200, such that client system 200 may submit job requests to the resource located within itself.

To implement the resource distribution functions from all resources within grid environment 150, grid services are available from each resource. Grid services may be designed according to multiple architectures, including, but not limited to, the Open Grid Services Architecture (OGSA). In particular, grid environment 150 is created by a management environment which creates a grid by linking computing systems into a heterogeneous network environment characterized by sharing of resources through grid services.

Grid environment 150, as managed by grid services distributed across the resources, may provide a single type of service or multiple types of services. For example, computational grids, scavenging grids, and data grids are example categorizations of the types of services provided in a grid environment. Computational grids may manage computing resources of high-performance servers. Scavenging grids may scavenge for CPU resources and data storage resources across desktop computer systems. Data grids may manage data storage resources accessible, for example, to multiple organizations or enterprises. It will be understood that a grid environment is not limited to a single type of grid categorization.

Referring now to FIG. 3, a block diagram illustrates one example of an architecture that may be implemented in a grid environment. As depicted, an architecture 300 includes multiple layers of functionality. As will be further described, the present invention is a process which may be implemented in one or more layers of an architecture, such as architecture 300, which is implemented in a grid environment, such as the grid environment described in FIG. 2. It is important to note that architecture 300 is just one example of an architecture that may be implemented in a grid environment and in which the present invention may be implemented. Further, it is important to note that multiple architectures may be implemented within a grid environment.

Within architecture 300, first, a physical and logical resources layer 330 organizes the resources of the systems in the grid. Physical resources include, but are not limited to, servers, storage media, and networks. The logical resources virtualize and aggregate the physical layer into usable resources such as operating systems, processing power, memory, I/O processing, file systems, database managers, directories, memory managers, and other resources.

Next, a web services layer 320 provides an interface between grid services 310 and physical and logical resources 330. Web services layer 320 implements service interfaces including, but not limited to, Web Services Description Language (WSDL), Simple Object Access Protocol (SOAP), and extensible mark-up language (XML) executing atop an Internet Protocol (IP) or other network transport layer. Further, the Open Grid Services Infrastructure (OSGI) standard 322 builds on top of current web services 320 by extending web services 320 to provide capabilities for dynamic and manageable Web services required to model the resources of the grid. In particular, by implementing OGSI standard 322 with web services 320, grid services 310 designed using OGSA are interoperable. In alternate embodiments, other infrastructures or additional infrastructures may be implemented a top web services layer 320.

Grid services layer 310 includes multiple services. For example, grid services layer 310 may include grid services designed using OGSA, such that a uniform standard is implemented in creating grid services. Alternatively, grid services may be designed under multiple architectures. Grid services can be grouped into four main functions. It will be understood, however, that other functions may be performed by grid services.

First, a resource management service 302 manages the use of the physical and logical resources. Resources may include, but are not limited to, processing resources, memory resources, and storage resources. Management of these resources includes receiving job requests, scheduling job requests, distributing jobs, and managing the retrieval of the results for jobs. Resource management service 302 preferably monitors resource loads and distributes jobs to less busy parts of the grid to balance resource loads and absorb unexpected peaks of activity. In particular, a user may specify preferred performance levels so that resource management service 302 distributes jobs to maintain the preferred performance levels within the grid.

Second, information services 304 manages the information transfer and communication between computing systems within the grid. Since multiple communication protocols may be implemented, information services 304 preferably manages communications across multiple networks utilizing multiple types of communication protocols.

Third, a data management service 306 manages data transfer and storage within the grid. In particular, data management service 306 may move data to nodes within the grid where a job requiring the data will execute. A particular type of transfer protocol, such as Grid File Transfer Protocol (GridFTP), may be implemented.

Finally, a security service 308 applies a security protocol for security at the connection layers of each of the systems operating within the grid. Security service 308 may implement security protocols, such as Open Secure Socket Layers (SSL), to provide secure transmissions. Further, security service 308 may provide a single sign-on mechanism, so that once a user is authenticated, a proxy certificate is created and used when performing actions within the grid for the user.

Multiple services may work together to provide several key functions of a grid computing system. In a first example, computational tasks are distributed within a grid. Data management service 306 may divide up a computation task into separate grid services requests of packets of data that are then distributed by and managed by resource management service 302. The results are collected and consolidated by data management system 306. In a second example, the storage resources across multiple computing systems in the grid are viewed as a single virtual data storage system managed by data management service 306 and monitored by resource management service 302.

An applications layer 340 includes applications that use one or more of the grid services available in grid services layer 310. Advantageously, applications interface with the physical and logical resources 330 via grid services layer 310 and web services 320, such that multiple heterogeneous systems can interact and interoperate.

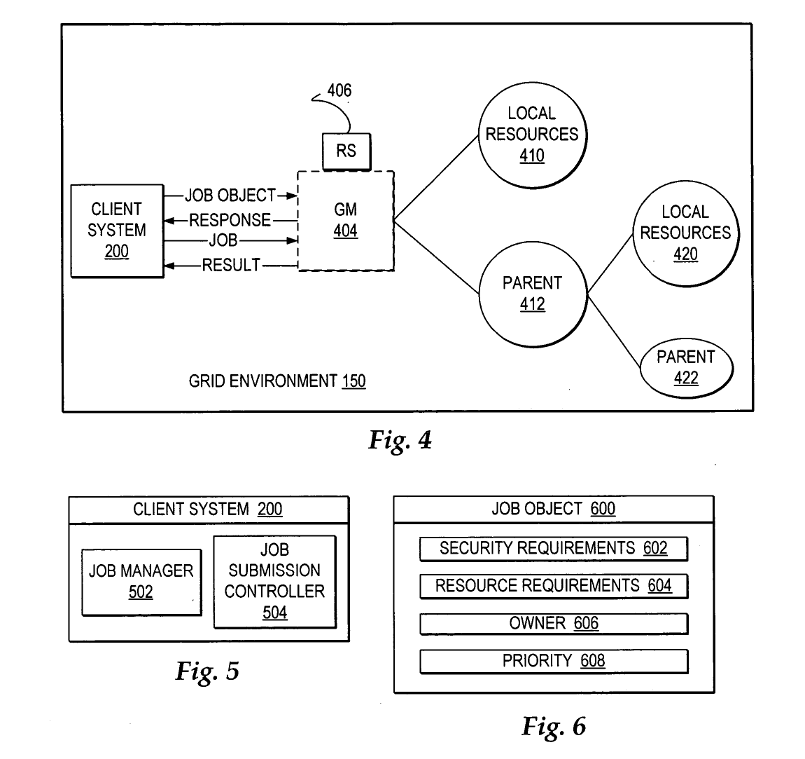

With reference now to FIG. 4, an illustrative representation depicts one embodiment of the logical infrastructure of a grid environment in which the present invention may be implemented. While FIG. 2 depicts an example of general components of a grid environment, in the present figure, an example of how the general components are viewed logically within a grid environment is illustrated in grid environment 150. In particular, the grid management system functions are logically dispersed into multiple grid managers (GM)s, such as GM 404. Further, the virtual resource is logically dispersed into multiple resources (RSs), each managed by a GM. It is important to note that a resource may not be a direct representation of a physical resource, but rather a logical representation of one or more physical resources and or groups of physical resources.

In the example, client system 200 sends a job to GM 404 of RS 406 with a job object defining the requirements of the job. In the example, RS 406 is the receiving resource, however it will be understood that any of the resources within grid environment 150 may act as a receiving resource. GM 404 searches for resources available to handle the job specified in the job object. First, GM 404 checks whether RS 406 can handle the job specified in the job object. If RS 406 cannot handle the job specified in the job object, then GM 404 determines the most suitable available resource for handling the job. Preferably, the GM for each resource initially receives updates about the availability of a selection of local resources 410, where each resource within local resources 410 includes a GM. As will be further described, the availability and ability updates may be received from a resource directory or from node description messages.

GM 404 determines whether to send the job to one of local resources 410. If none of local resources 410 is available and able to handle the job, then GM 404 access a next level of resources within grid environment 150 through parent node 412. For example, each parent node 412 enables access to availability and ability information about local resource 420 and parent node 422. Thus, if RS 406 is not able to handle the job specified in the job object, then the job is dynamically routed through the grid environment to the most suitable available resource.

According to one advantage of non-centralized job routing, simple routing of job objects within grid environment is achieved by enabling each resource to acquire information about each other resource within the grid environment. According to another advantage of non-centralized job routing, jobs are dynamically routed around failed resources because each resource updates other resources as to current availability.

It is important to note that GM 404 and RS 406 may be physically located within client system 200. Alternatively, GM 404 and RS 406 may be accessible via a network, where a web service accessible at a particular network address executes on GM 404.

Once GM 404 locates the most suitable resource for the job object or determines that no resource is available to handle the job object, GM 404 returns a response to client system 200. Further, a result received at GM 404 is returned to client system 200. It will be understood, however, that if the job is handed off to another resource, other than RS 406, that resource may establish a connection with client system 200 and return the result to client system 200 without routing through GM 404.

The resources utilized in processing the job form a virtual organization within virtual environment 150 for handling the job. In particular, multiple resources may be required to handle a job, where the combination of resources forms a virtual organization for handling the job. Further, in particular, if a resource is handling the job, but cannot complete the job to meet performance requirements, the resource may automatically allocate additional resources to form a virtual organization for handling a job according to quality of service specifications.

With reference now to FIG. 5, there is depicted a block diagram of a client system for interfacing with a grid environment. As depicted, a client system 200 preferably interfaces with a resource or resources of a grid environment. In the embodiment depicted, client system 200 include a job manager 502 and a job submission controller 504. It will be understood that additional controllers and managers may be implemented in client system 200 to enable client system 200 to interface with the grid environment.

Job manager 502 preferably organizes jobs and monitors job results. In particular, client system 200 may submit multiple jobs that are simultaneously executing within the grid environment, where job manager 502 manages the results returned from the multiple jobs.

Job submission controller 504 preferably controls submission of jobs to a resource of the grid environment dependent on the type of network connection available to the client system 200. For example, if client system 200 also includes grid resources, then the job may first be submitted to the local system grid resources residing within client system 200. Alternatively, if client system 200 does not include grid resources, then the job may be submitted to the next local resource. To locate the next local resource, a web service may run on each of the resources within the grid and an intelligent DNS server accessible to client system 200 may resolve the DNS name entered through a browser to locate the nearest resource. In another example, a physical address of a specific next local resource may be provided from client system 200. For example the address “www.grid.com” may be used to access the next local resource by client systems located in the United States and the address “www.grid.co.uk” may be used to access the next local resource by client systems located in the United Kingdom.

When job submission controller 504 submits a job to a grid resource, the act of submission requires job submission controller 504 to create a job object. The job object is generally a message which contains information about how to run a job and the quality of service required for the job. Each of the resources within the grid environment is preferably enabled to parse the job object and determine if the resource can execute the job meeting the requirements of the job object.

Referring now to FIG. 6, there is depicted a block diagram of a job object for a job submitted within a grid environment in accordance with the method, system, and program of the present invention. Job object 600 is preferably an object or file that contains all the information necessary to allow a grid resource to make a determination as to what is required to successfully execute a job submitted to a resource in the grid environment. In one embodiment, job object 600 may be an Extensible Mark-Up Language (XML) file with information about the job. It will be understood, however, that other types of language files and objects may describe job object 600.

Preferably, when a job is submitted to the grid infrastructure, job object 600 is created by the submitter. Then, each resource within the grid infrastructure is able to parse the job object and decide whether to execute the job or decide where the job object should be sent. In one embodiment, job object 600 includes security requirements 602, resource requirements 604, an owner 606, and a priority 608. It will be understood that other types of information may also describe job object 600.

Security requirements 602 may designate the security level, types of security and other requirements for a job. For example, security requirements 602 may designate the security requirement that a valid user identification and password will be needed to execute the job. In another example, security requirements 602 may designate the security information that the resource executing a job will need to access third party data.

Resource requirements 604 may designate the types of resources needed by the job for successful execution and completion. Types of resources may include, for example, a type of operating system required, a number of processors required, and the amount of memory needed.

Owner 606 designates the originator or submitter of the job. As a job is passed from one resource system to another, it is important to identify the originator or submitter of the job. Further, it is important to identify the originator or submitter of the job because resource access may be specified for each owner. Referring back to FIG. 5, client system 200 may be the submitter of the job. Alternatively, another system may submit jobs to client system 200, where client system 200 interfaces with grid environment 160 to submit the job to grid environment 160.

Priority 608 may designate the priority of a job according to a priority scale. For example, if priority 608 indicates that a job is submitted with a high priority, job object 600 is flagged to ensure that it is examined first or executed with the fastest resources. The level set in priority 608 may directly correlate with the cost of executing a job. Priority 608 may be designated by owner 606 or by another system with access to job object 600.

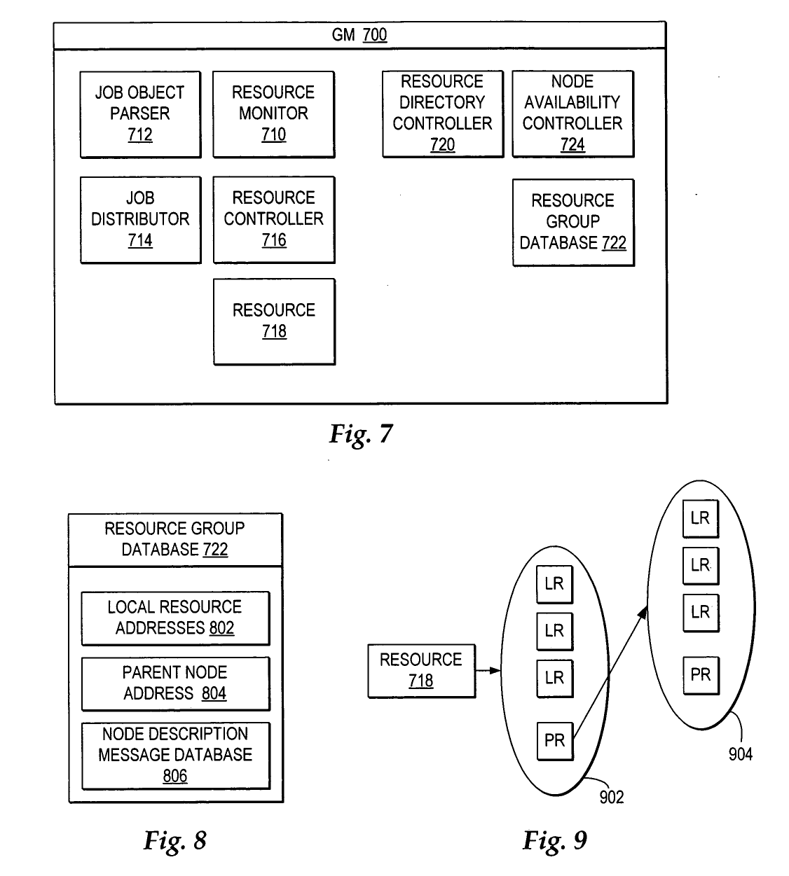

With reference now to FIG. 7, there is depicted a block diagram of a grid manager for each resource in accordance with the method, system, and program of the present invention. First, GM 700 includes a job object parser 712 for receiving and parsing job objects. Job distributor 714 compares the parsed job object requirements with current resource availability of resource 718 as detected and reported by resource monitor 710.

If job distributor 714 detects a match between the job object requirements and the current resource availability, then job distributor 714 will agree to run the job and the job is handed off to resource controller 716. In the case where resource controller 716 is local within the same GM to which the job is originally submitted, the job is run locally. In the case where resource controller 716 is not within the same GM to which the job is submitted, the job must be transferred to resource controller 716 with additional security requirements fulfilled.

If job distributor 714 does not detect a match between the job object information and the current resource availability, then job distributor 714 will determine the most suitable available resource to handle the job. According to an advantage of the present invention, each resource within a grid environment broadcasts availability information. The availability information is then preferably organized so that a GM searching for the most suitable resource to handle a job will locate the closest, most suitable resource. For purposes of example, organization of availability information is described with reference to a hierarchical resource directory system and with reference to a peer-to-peer resource distribution system. It will be understood, however, that other organization methods for distributing availability information for resources so that each resource within a grid environment can schedule and distribute jobs may be implemented.

In a grid environment implementing a hierarchical resource directory system, resource directory controller 720 communicates with a local resource directory to receive a list of other resources which may be able to execute the job and the availability of those other resources. According to an advantage of the hierarchical resource directory system, each resource updates a local resource directory with an availability and ability of the resource. In particular, resource directory controller 724 will detect the current availability of resource 718 from resource monitor 710 and send availability updates to the local resource directory.

Continuing with the hierarchical resource directory system, job distributor 714 parses the local resource list for a match with the job requirements of a job object. If job distributor 714 finds a match with a local resource, then job distributor 714 connects to the local resource and sends the job object to the local resource. The job distributor of the resource receiving the job object determines whether to accept or reject the job. If the job is accepted, then job distributor 714 passes the job to the local resource job controller. If the job is rejected, then resource directory controller 720 connects to the local resource directory to ask for the parent node of the local resource directory. The local resource directory returns the parent node address. Resource directory controller 720 then communicates with the parent resource directory and requests a list of additional resources. Resource directory controller 720 may continue to ask for the address of the parent node of each resource directory along the hierarchy of resource directories, such that each resource within the grid environment is enabled to access information about the availability and ability of all the other resources within the grid environment. Advantageously, a job object may include a timeout counter with a limit as to the number of resource directory accesses performed before the job is returned with an indicator that resources are not currently available for the job.

In a grid environment implementing a peer-to-peer resource distribution system, node availability controller 724 receives information about the availability of other resources in the form of node description messages received from other resources. A node description message preferably includes the address of the resource, the policies associated with the resource, the type of resource, whether the resource is available to accept jobs, and an expiration time for the node description message. Node availability controller 724 stores node description messages in resource group database 722. Node availability controller 724 also passes the node description messages received from other resources to local resources and a parent resource registered in resource group database 722. In addition, node availability controller 724 sends node description messages for resource 718 to the local resources and parent resource registered in resource group database 722. Thus, either directly or indirectly, each node description message about each resource will be accessible by each resource within the grid environment.

Next, in a peer-to-peer resource distribution system, job distributor 714 compares a job object with the node description messages stored in resource group database 722. If there is not a match between the job object and the node description messages for resources in resource group database 722, then job distributor 714 will pass the job object to the parent resource. A parent resource then performs the same matching attempt. The job object may be passed from a parent resource to a parent resource in search of the most suitable resource until the most suitable resource is located or the job object times out.

With reference now to FIG. 8, there is depicted a block diagram of a resource group database used in a peer-to-peer resource distribution system in accordance with the method, system, and program of the present invention. In general, in a peer-to-peer resource directory implementation, each resource knows about a selection of local resources and a parent resource. The parent resource acts as a gateway to the rest of the grid environment because it knows about at least one other resource outside the local directory. Preferably all the resources in the grid environment are linked through parent resource gateways in a peer-to-peer network. A protocol modeled after the Routing Information Protocol (RIP) implemented within the Internet for determining how to route packets may be implemented for allowing each grid resource to determine how to route jobs through the grid network to the most suitable resource for a job.

Within the peer-to-peer implementation, each resource sends information about itself to a selection of local resources and its parent resource. In particular, each resource has a resource group database 722 that includes local resources addresses 802 and a parent node address 804 designating the local and parent resources to which node description messages are to be sent. Further, in particular, resource group database 722 includes a node description message database 806 in which node description messages received from other resources are stored.

Referring now to FIG. 9, there is depicted a block diagram of a logical representation of a peer-to-peer resource distribution system in accordance with the method, system, and program of the present invention. As illustrated, resource 718 sends node description messages to a selection of local resources (LR) and a parent node resource (PR) within grouping 902. If a job cannot be handled by one of the LR within group 902, then resource will send the job object to the PR of group 902. The PR of group 902 acts as a gateway to the other resources of the grid environment for resource 718 and determines whether any of the LRs in group 904 are available to handle the job. In particular, the PR maintains addresses to access the LRs and PR in group 904 and receives node description messages from each of the resources in group 904. Although not depicted, the PR of group 904 further maintains addresses for another group of LRs and a PR. Thus, by providing each resource with the addresses of local resource and a parent resource that accesses other resources, a peer-to-peer implementation. Advantageously, by implementing a peer-to-peer resource distribution system, routing of job objects within the grid infrastructure is simplified, jobs are dynamically routed around failed resources, and the available resources within a grid environment are automatically updated.

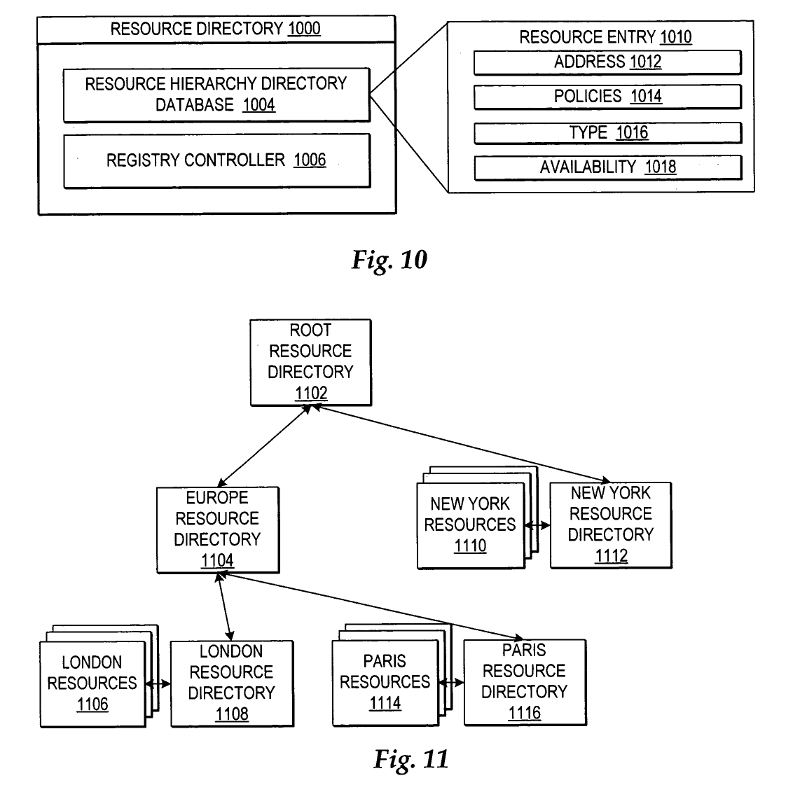

With reference now to FIG. 10, there is depicted a block diagram of a resource directory in a hierarchical resource directory system in accordance with the method, system, and program of the present invention. As illustrated, a resource directory 1000 includes a resource hierarchy directory database 1004. Resource hierarchy directory database 1004 preferably maintains a directory of the availability and ability of a selection of local resources. In particular, for each resource, a resource entry 1010 is preferably maintained. Each resource entry preferably includes the address 1012 of the resource, the resource policies 1014, the type of resource 1016, and the resource availability 1018. Resources preferably send updates to resource entries as an address location, policies, or availability changes. A registry controller 1006 preferably controls the updates of resource entries in resource hierarchy directory database 1004.

Resource directory 1010 receives requests for resource lists of available resources from a local resource group. Registry controller 1006 searches resource hierarchy directory database 1004 for local resource availability and returns a list of the resource entries for available resources to the requesting resource.

Resource directory 1010 is preferably implemented within a grid resource that is also available to handle other jobs. In alternate embodiments, however, resource directory 1010 may be implemented within a resource that only provides directory services or multiple directories may be implemented within a single resource.

In view of FIG. 4, resource directory 1010 is classified as a parent node through which a local resource has access to other resources in the grid environment. In particular, however, a resource directory at the top of the hierarchy may be classified as a root directory that does not have a parent node.

Referring now to FIG. 11, there is depicted an illustrative representation of a hierarchical resource directory in accordance with the method, system, and program of the present invention. As depicted, each set of resources is managed by a local resource directory. Then, each of the resources directories is connected in a hierarchical fashion. In particular, in the example, a London resource directory 1108 maintains a directory for local London resources 1106, a Paris resource directory 1116 maintains a directory for local Paris resources 1114, and the New York resource directory 1112 maintains a directory for local New York resources 1110. Then, a Europe resource directory 1104 receives information from London resource directory 1108 and Paris resource directory 1116. Finally, a root resource directory 1102 receives directory information from Europe resource directory 1104 and New York resource directory 1112.

Grid jobs can be submitted from any resource within grid hierarchy 1100 where resources include London resources 1106, Paris resources 1114, and New York resources 1110. Each resource accesses the local resource directory to determine whether a local resource or the receiving resource from which the job is submitted can execute the job. If the receiving resource can execute the job, then the receiving resource executes the job and updates the local resource directory with availability to accept other jobs. If the receiving resource cannot execute the job, then the receiving resource accesses the local resource directory to determine if a local resource meets all the requirements of the job object. If a local resource meets all the requirements of the job object, then the address of the local resource is accessed and the job object is sent to the local resource address.

Advantageously, by organizing grid resources locally, jobs will most likely be submitted and executed within one local area of the grid without affecting other areas of the grid. If, however, local resources are not able to handle current jobs, a resource directory higher up in the grid hierarchy is accessible to determine whether grid resources in other areas are available to handle the jobs.

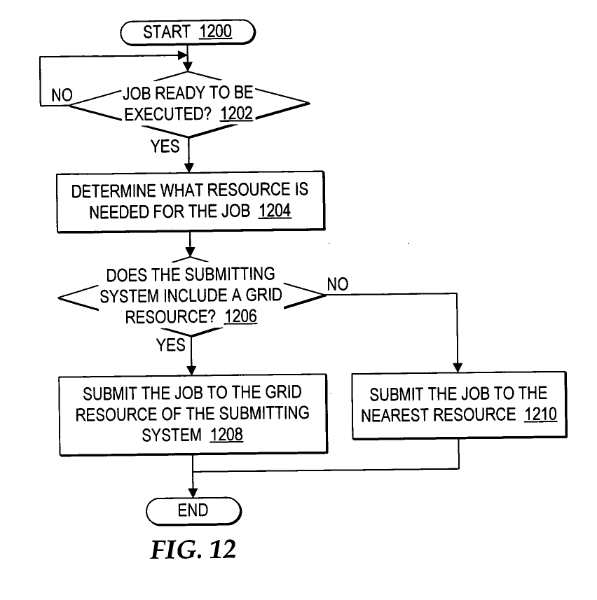

With reference now to FIG. 12, there is depicted a high level logic flowchart of a process and program for controlling a grid job submission from a client system in accordance with the method, system, and program of the present invention. As depicted, the process starts at block 1200 and thereafter proceeds to block 1202. Block 1202 depicts a determination whether there is a job ready to be executed. If there is not a job ready to be executed, then the process iterates at block 1202. If there is a job ready to be executed, then the process passes to block 1204. Block 1204 depicts determining what resource is needed for the job. Although not depicted, multiple resources may be needed for the job. Next, block 1206 depicts a determination whether the submitting system includes a grid resource. If the submitting system includes a grid resource, then the process passes to block 1208. Block 1208 depicts submitting the job to the submitting system grid resource, and the process ends. At block 1206, if the submitting system does not include a grid resource, then the process passes to block 1210. Block 1210 depicts submitting the job to the nearest resource, and the process ends.

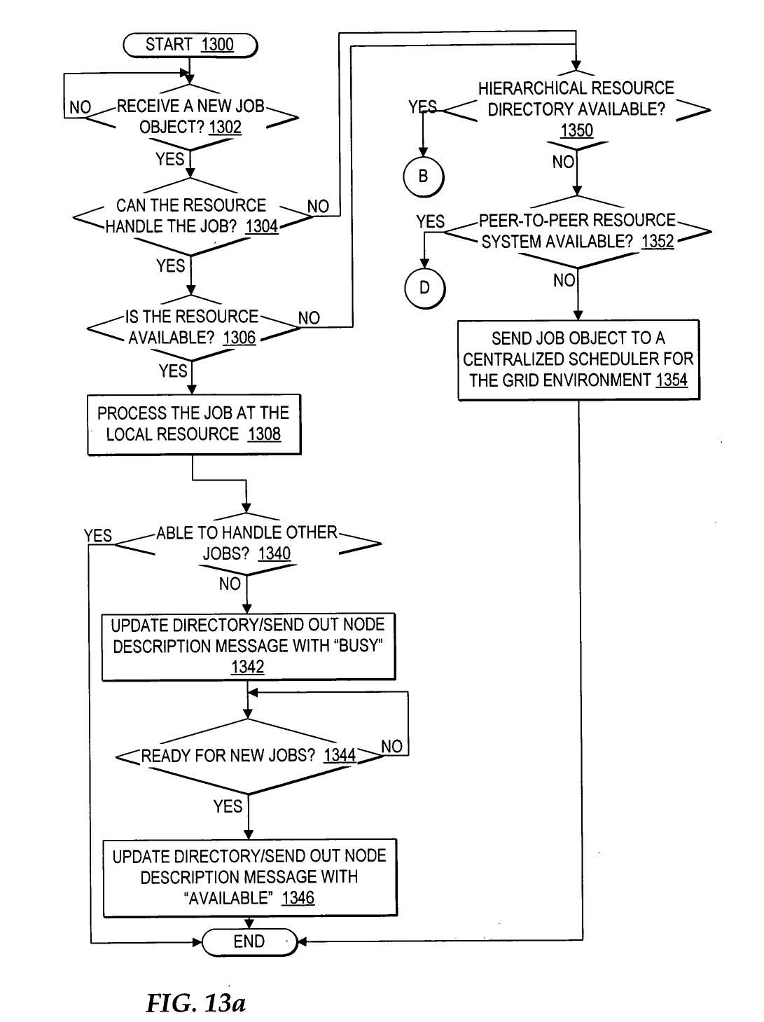

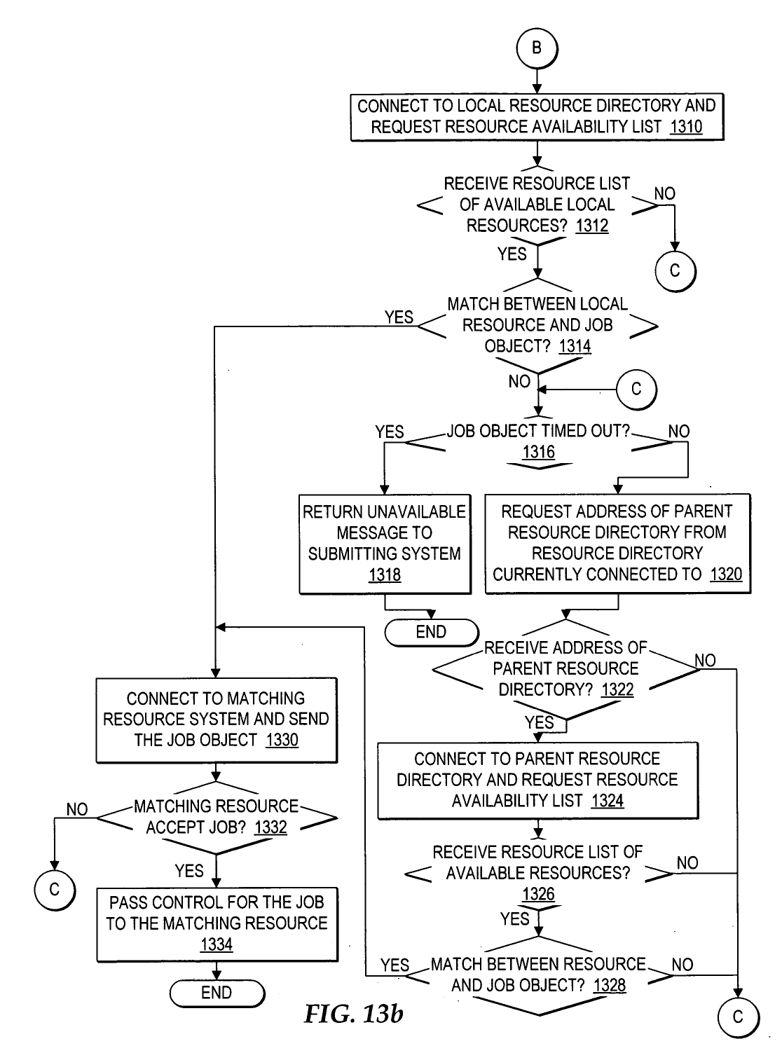

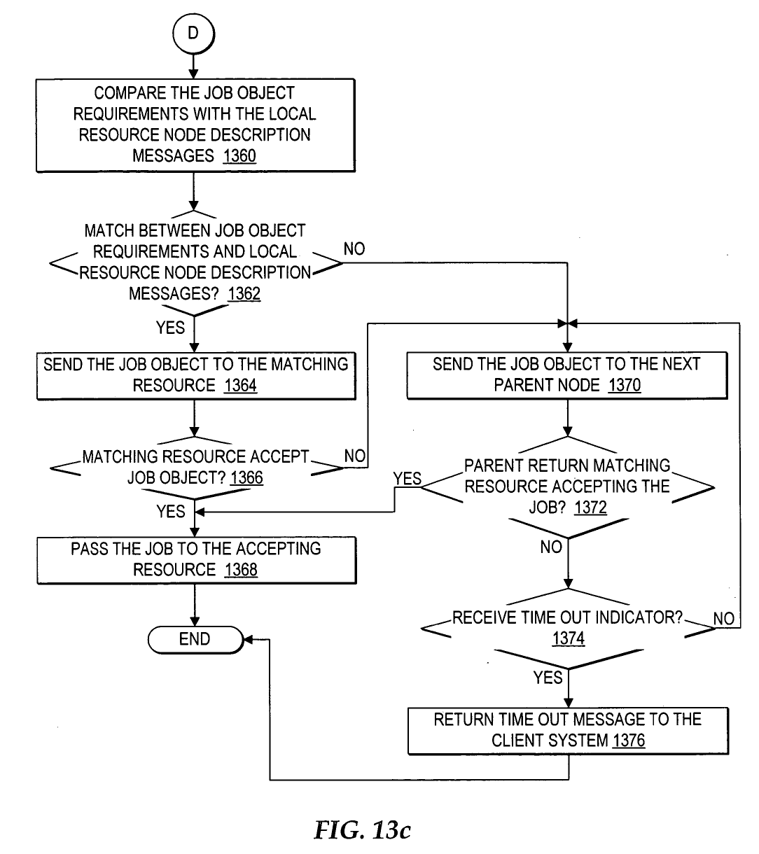

Referring now to FIGS. 13a-13c, there is depicted a high level logic flowchart of a process and program for controlling the distribution of a new job object from any resource within the grid environment in accordance with the method, system, and program of the present invention. As depicted, the process starts at block 1300 and thereafter proceeds to block 1302. Block 1302 depicts a determination whether a new object is received. If a new object is not received, then the process iterates at block 1302. If a new object is received, then the process passes to block 1304.

Block 1304 depicts a determination whether the resource receiving the job object can handle the job. If the resource can handle the job, then the process passes to block 1306. Block 1306 depicts a determination whether the resource is available. If the resource is not available, then the process passes to block 1350, which will be further described. If the resource is available, then the process passes to block 1308. Block 1308 depicts processing the job at the local resource, and the process passes to block 1340.

Block 1340 depicts a determination whether the resource is able to handle other jobs. If the resource is able to handle other jobs, then the process ends. If the resource is not able to handle other jobs, then the process passes to block 1342. Block 1342 depicts updating the local resource directory or sending a node description message to the local and parent resources indicating the resource is “busy”. Next, block 1344 depicts a determination whether the resource is ready for new jobs. If the resource is not ready for new jobs, then the process iterates at block 1344. If the resource is ready for new jobs, then the process passes to block 1346. Block 1346 depicts updating the local resource directory or sending a node description message to the local and parent resources indicating the resources is “available”, and the process ends.

Returning to block 1304, if the resource is not able to handle the job, then the process passes to block 1350. Block 1350 depicts a determination whether a hierarchical resource directory is available. If a hierarchical resource directory is not available, then the process passes to block 1310 of FIG. 13b. If a hierarchical resource directory is not available, then the process passes to block 1352. Block 1352 depicts a determination whether a peer-to-peer resource system is available. If a peer-to-peer resource system is available, then the process passes to block 1360 of FIG. 13c. If a peer-to-peer resource system is not available, then the process passes to block 1354. Block 1354 depicts sending the job object to a centralized scheduler for the grid environment or other system that handles job objects, and the process ends.

Describing the hierarchical resource directory system, block 1310 of FIG. 13b depicts connecting to a local resource directory and requesting the resource availability list. Next, block 1312 depicts a determination whether a list of available local resources is received. If a list of available local resources is not received, then the process passes to block 1316, which will be further described. If a list of available local resources is received, then the process passes to block 1314. Block 1314 depicts a determination whether there is a match between the availability and ability of the local resource and the requirements of the job object. If there is not a match between the local resource and the job object, then the process passes to block 1316.

Block 1316 depicts a determination whether the job object is timed out. In particular, a counter may be decremented with each access to a resource directory or other action taken while the resource attempts to locate the most suitable resource. Once the counter reaches null, then the job object is determined to have timed out. If the job object is timed out, then the process passes to block 1318. Block 1318 depicts returning an unavailable message to the submitting system. If the job object is not timed out, then the process passes to block 1320. Block 1320 depicts requesting the address of a parent resource directory from the resource directory currently connected to by the resource. Next, block 1322 depicts a determination whether an address of a parent resource directory is received. If an address of a parent resource directory is not received, then the process passes to block 1316. If an address of a parent resource directory is received, then the process passes to block 1324. Block 1324 depicts connecting to the parent resource directory and requesting an availability list. Next, block 1326 depicts a determination whether a list of available resources is received. If a list of available resources is received, then the process passes to block 1328, otherwise, the process passes to block 1316. Block 1328 depicts a determination whether there is a match between the availability and ability of the local resource and the requirements of the job object. If there is a match between the availability and ability of the local resource and the requirements of the job object, then the process passes to block 1330, otherwise the process passes to block 1316.

Returning to block 1314, if there is a match between the availability and ability of the local resource and the requirements of the job object, then the process passes to block 1330. Block 1330 depicts connecting to the matching resource system and sending the job object to the matching resource. Next, block 1332 depicts a determination whether the matching resource system accepts the job. If the matching resource system accepts the job, then the process passes to block 1334, otherwise the process passes to block 1316. Block 1334 depicts passing control for the job to the matching resource, and the process ends.

Describing the peer-to-peer resource system, block 1360 of FIG. 13c depicts comparing the job object requirements with the local resource node description messages at the resources. The process of block 1360 assumes that the resource receives node description messages from other local resources and stores those node description messages. Next, block 1362 depicts a determination whether there is a match between the job object requirements and one of the local resource node description messages. If there is a match, then the process passes to block 1364. Block 1364 depicts sending the job object to the matching resource. Next, block 1366 depicts a determination whether the matching resource accepts the job object. If the matching resource does not accept the job object, then the process passes to block 1370. If the matching resource does accept the job object, then the process passes to block 1368.

If there is not a match, then the process passes to block 1370. Block 1370 depicts sending the job object to the next parent node. Thereafter, block 1372 depicts a determination whether the parent returns a matching resource accepting the job. If the parent returns a matching resource accepting the job, then the process passes to block 1368. If the parent does not return a matching resource accepting the job, then the process passes to block 1374. Block 1374 depicts a determination whether a time out indicator is received. If a time out indicator is not received, then the process returns to block 1372. If a time out indicator is received, then the process passes to block 1376. Block 1376 depicts returning a time out message to the client system, and the process ends. Preferably, as the job object is passed from one parent node to the next, either a match among the resource known by each parent node will be found or the search for a resource will time out.

While the invention has been particularly shown and described with reference to a preferred embodiment, it will be understood by those skilled in the art that various changes in form and detail may be made therein without departing from the spirit and scope of the invention.

What is claimed is:

1. A job distribution system within a grid environment, comprising:
a plurality of resources connected within a grid environment, wherein each of said plurality of resources is enabled to handle grid jobs;
each of said plurality of resources further comprising:
means for distributing an availability status to handle grid jobs within said grid environment;
means for accessing said availability status of all of said plurality of resources within said grid environment;
means for receiving a job object describing at least one requirement for a grid job submitted to a receiving resource from among said plurality of resources;
means for determining a most suitable resource from among said plurality of resources, wherein said most suitable resource meets said at least one requirement for said job and said availability status indicates availability to handle said job; and
means for controlling submission of said job from said receiving resource to said most suitable resource for handling said job.

2. The job distribution system according to claim 1, wherein said means for distributing an availability status to handle grid jobs within said grid environment further comprises:
means for distributing a node description message to a selection of local resources from among said plurality of resources and a parent resource from among said plurality of resources, wherein said node description message specifies said availability status, wherein said parent resource distributes said node description message to a second selection of local resources from among said plurality of resource and a second parent resource from among said plurality of resources.

3. The job distribution system according to claim 1, wherein said means for distributing an availability status to handle grid jobs within said grid environment further comprises:
a local resource directory for maintaining a current availability of a selection of local resources from among said plurality of resources, wherein said local resource directory is one from among a plurality of resource directories through which said availability status of all said plurality of resources is managed; and
said selection of local resources further comprising means for updating said local resource directory with said availability status of each of said selection of local resources.

4. The job distribution system according to claim 1, wherein said means for accessing said availability status of all of said other plurality of resources within said grid environment, further comprises:
means for receiving and storing a plurality of node description messages at said receiving resource, wherein each of said plurality of node description messages indicates said availability status of one from among a selection of local resources from among said plurality of resources; and
means for accessing said availability status for a remainder of resources from among said other plurality of resources through a parent node, wherein said parent node accesses a second selection of local resources from among said plurality of resource and a second parent node from among said plurality of resources.

5. The job distribution system according to claim 1, wherein said means for accessing said availability status of all of said other plurality of resources within said grid environment, further comprises:
means for requesting said availability status of a selection of local resources from a local resource directory, wherein said local resource directory receives messages indicating said availability status from said selection of local resources, wherein said local resource directory is one of a plurality of resource directories linked in a hierarchy.

6. The job distribution system according to claim 1, wherein said means for determining a most suitable resource from among said plurality of resources further comprises:
means for searching a first selection of local resources from among said plurality of resources for said most suitable resource, wherein said first selection of local resources are within a first geographic proximity of said receiving resource; and
means for only searching a next selection of resources from among said plurality of resources for said most suitable resource if said first selection of local resources is insufficient for said job, wherein said next selection of resources are within a second geographic proximity of said receiving resource.

7. A method for job distribution from any of a plurality of resources within a grid environment, comprising:
enabling a plurality of resources connected within a grid environment to handle grid jobs;
distributing, from each of said plurality of resources, an availability status of each of said plurality of resources to handle grid jobs within said grid environment;
enabling each of said plurality of resource to access said availability status for of all of said other plurality of resources within said grid environment;
receiving a job object describing at least one requirement for a grid job submitted to a receiving resource from among said plurality of resources;
determining a most suitable resource from among said plurality of resources, wherein said most suitable resource meets said at least one requirement for said job and said availability status indicates availability to handle said job; and
controlling submission of said job from said receiving resource to said most suitable resource for handling said job, such that job distribution from any resource receiving a job object is accomplished without a centralized job scheduler.

8. The method for job distribution according to claim 7, wherein distributing, from each of said plurality of resources, an availability status further comprises:
distributing a node description message to a selection of local resources from among said plurality of resources and a parent resource from among said plurality of resources, wherein said node description message specifies said availability status, wherein said parent resource receives node description messages from a second selection of local resources from among said plurality of resources and distributes job objects to a second parent resource from among said plurality of resources.

9. The method for job distribution according to claim 7, wherein distributing, from each of said plurality of resources, an availability status further comprises:
maintaining a current availability of a selection of local resources from among said plurality of resources at a local resource directory, wherein said local resource directory is one from among a plurality of resource directories through which said availability status of all said plurality of resources is managed; and
updating, from each of said selection of local resources, said local resource directory with said availability status of each of said selection of local resources.

10. The method for job distribution according to claim 7, wherein enabling each of said plurality of resource to access said availability status for of all of said other plurality of resources within said grid environment further comprises:
receiving and storing a plurality of node description messages at said receiving resource, wherein each of said plurality of node description messages indicates said availability status of one from among a selection of local resources from among said plurality of resources; and
accessing said availability status for a remainder of resources from among said other plurality of resources through a parent node, wherein said parent node accesses a second selection of local resources from among said plurality of resource and a second parent node from among said plurality of resources.

11. The method for job distribution according to claim 7, wherein enabling each of said plurality of resource to access said availability status for of all of said other plurality of resources within said grid environment further comprises:
requesting said availability status of a selection of local resources from a local resource directory, wherein said local resource directory receives messages indicating said availability status from said selection of local resources, wherein said local resource directory is one of a plurality of resource directories linked in a hierarchy.

12. The method for job distribution according to claim 7, wherein determining a most suitable resource from among said plurality of resources further comprises:
searching a first selection of local resources from among said plurality of resources for said most suitable resource, wherein said first selection of local resources are within a first geographic proximity of said receiving resource; and
only searching a next selection of resources from among said plurality of resources for said most suitable resource if said first selection of local resources is insufficient for said job, wherein said next selection of resources are within a second geographic proximity of said receiving resource.

13. A computer program product residing on a computer readable medium for job distribution from any of a plurality of resources within a grid environment, said computer readable medium comprising:
means for enabling a plurality of resources connected within a grid environment to handle grid jobs;
means for distributing, from each of said plurality of resources, an availability status of each of said plurality of resources to handle grid jobs within said grid environment;
means for enabling each of said plurality of resource to access said availability status for of all of said other plurality of resources within said grid environment;
means for receiving a job object describing at least one requirement for a grid job submitted to a receiving resource from among said plurality of resources;
means for determining a most suitable resource from among said plurality of resources, wherein said most suitable resource meets said at least one requirement for said job and said availability status indicates availability to handle said job; and
means for controlling submission of said job from said receiving resource to said most suitable resource for handling said job, such that job distribution from any resource receiving a job object is accomplished without a centralized job scheduler.

14. The computer program product for job distribution according to claim 13, wherein said means for distributing, from each of said plurality of resources, an availability status further comprises:
means for distributing a node description message to a selection of local resources from among said plurality of resources and a parent resource from among said plurality of resources, wherein said node description message specifies said availability status, wherein said parent resource receives node description messages from a second selection of local resources from among said plurality of resources and distributes job objects to a second parent resource from among said plurality of resources.

15. The computer program product for job distribution according to claim 13, wherein said means for distributing, from each of said plurality of resources, an availability status further comprises:
means for maintaining a current availability of a selection of local resources from among said plurality of resources at a local resource directory, wherein said local resource directory is one from among a plurality of resource directories through which said availability status of all said plurality of resources is managed; and
means for updating, from each of said selection of local resources, said local resource directory with said availability status of each of said selection of local resources.

16. The computer program product for job distribution according to claim 13, wherein said means for enabling each of said plurality of resource to access said availability status for of all of said other plurality of resources within said grid environment further comprises:
means for receiving and storing a plurality of node description messages at said receiving resource, wherein each of said plurality of node description messages indicates said availability status of one from among a selection of local resources from among said plurality of resources; and
means for accessing said availability status for a remainder of resources from among said other plurality of resources through a parent node, wherein said parent node accesses a second selection of local resources from among said plurality of resource and a second parent node from among said plurality of resources.

17. The computer program product for job distribution according to claim 13, wherein said means for enabling each of said plurality of resource to access said availability status for of all of said other plurality of resources within said grid environment further comprises:
means for requesting said availability status of a selection of local resources from a local resource directory, wherein said local resource directory receives messages indicating said availability status from said selection of local resources, wherein said local resource directory is one of a plurality of resource directories linked in a hierarchy.

18. The computer program product for job distribution according to claim 13, wherein said means for determining a most suitable resource from among said plurality of resources further comprises:
means for searching a first selection of local resources from among said plurality of resources for said most suitable resource, wherein said first selection of local resources are within a first geographic proximity of said receiving resource; and
means for only searching a next selection of resources from among said plurality of resources for said most suitable resource if said first selection of local resources is insufficient for said job, wherein said next selection of resources are within a second geographic proximity of said receiving resource.

19. A hierarchical job distribution system within a grid environment, comprising:
a plurality of resources within a grid environment;
a plurality of resource directories, wherein each of said plurality of resource directories maintains said availability and at least one characteristic of each of a selection of said plurality of resources, wherein said plurality of resource directories are hierarchically arranged; and
a job submitted to a receiving resource from among said plurality of resources, wherein said receiving resource requests of said selection of said plurality of resources from a particular resource directory accessible to said receiving resource, wherein said receiving resource determines whether any of said selection of said plurality of resources is enabled to handle said job, wherein responsive to said selection of said plurality of resources not being enabled to handle said job said receiving resource requests an address of another resource directory from said particular resource directory, wherein said receiving resource requests said availability of a second selection of said plurality of resources.

20. The hierarchical job distribution system of claim 19 wherein any of said plurality of resources is enabled to act as said receiving resource.

21. The hierarchical job distribution system of claim 19 wherein said job is submitted with a job object, wherein said job object describes at least one requirement for said job.

22. A peer-to-peer job distribution system within a grid environment, comprising:
a plurality of resources within a grid environment; and
each of said plurality of resources further comprising:
means for distributing an availability message to a selection of local resources and a parent resource;
means for receiving and storing said availability messages from local resources and parent resources;
means for receiving a job object describing at least one requirement for a grid job submitted to one of said plurality of resources;
means for determining a most suitable resource meeting said at least one requirement for said grid job based on said stored availability messages; and
means for controlling submission of said job from said one of said plurality of resources determining said most suitable resource to said most suitable resource.
